(19) United States
(12) Patent Application Publication
(10) Pub. No.: US 2017/0211579 A1
(43) Pub. Date: Jul. 27, 2017

(54) NOSE CONE FOR A FAN OF AN AIRCRAFT ENGINE

(71) Applicant: Rolls-Royce Deutschland Ltd & Co KG, Blankenfelde-Mahlow (DE)

(72) Inventor: Thomas KLAUKE, Luebbenau/Spreewald OT Gross-Beuchow (DE)

(21) Appl. No.: 15/415,341

(22) Filed: Jan. 25, 2017

(30) Foreign Application Priority Data
Jan. 27, 2016 (DE) 10 2016 101 428.1

(51) Int. Cl. F04D 29/02; F04D 29/32; F04D 29/34

(52) U.S. Cl. CPC F04D 29/023; F04D 29/34; F04D 29/325; F05D 2300/603; F05D 2300/30; F05D 2300/431; F05D 2300/701; F05D 2250/232; F05D 2220/36

(57) ABSTRACT

A nose cone for a fan of an aircraft engine that comprises a cone part of fiber-reinforced material. It is provided that an elastomer is integrated into the cone part. The invention further relates to a fan and an aircraft engine with such a nose cone.

### REFERENCE TO RELATED APPLICATION

This application claims priority to German Patent Application No. 10 2016 101 428.1 filed on Jan. 27, 2016, the entirety of which is incorporated by reference herein.

### BACKGROUND

The invention relates to a nose cone for a fan of an aircraft engine.

It is a known problem that the fan blades of an aircraft engine may be stimulated to vibrate due to a variety of different flow conditions. At that, the chance of undesired vibrations of the fan blades occurring is especially high when the fan is manufactured in an integral BLISK design (BLISK=“blade integrated disc”), i.e., as a structural component that is formed in one piece and comprises the fan blades as well as the fan disc, or that is realized in an integral BLING design (BLING=“bladed ring”), i.e., with the blades being manufactured integrally with the supporting ring. This has to do with the fact that fans manufactured in an integral design do no longer have separate blade-disc connections that contribute to the mechanical damping of the system.

Due to the lower degree of mechanical damping of integral blade-disc constructions, the maximal vibration amplitude of the fan blades is caused almost exclusively by the aerodynamic boundary conditions. This may lead to strong stress and deformation in particular in operational states with a low or even negative aerodynamic damping (flutter), which has a strong negative effect on the service life of the fan, or may even cause incipient cracks.

Typically, the fan module also comprises a nose cone that is arranged upstream of the fan disc on the rotational axis of the fan and deflects the air flow in the direction of the fan blades. Such a nose cone is also referred to as an inlet cone, as a spinner, or as a rotating central body. It is known to manufacture a nose cone from a fiber composite material by using individual fiber layers, coiled fibers, or fiber bundles. Such manufacturing methods are known from EP 1 832 733 B1, DE 10 2010 005 986 A1 and DE 10 2010 005 987 B4, for example, the description of which is incorporated by reference.

There is a need to provide measures due to which the damping characteristics of a fan, in particular of a fan in BLISK or BLING design, are improved, so that the fan is less prone to vibration excitation.

### SUMMARY

According to a first aspect of the invention, an elastomer is integrated into a cone part of a nose cone made of fiber-reinforced material. Here, the cone part is a component of the nose cone or forms the entire nose cone. Further components of a nose cone can be structures for connecting the nose cone to a fan disc as well as a rubber tip.

By integrating the elastomer in the fiber-reinforced composite of the cone part, the mechanical damping that is caused in the fan blades by such a cone part connected to the fan can be increased to a considerable degree as compared to a composite structural component made of fiber-reinforced plastics alone. This leads to a desired reduction of the vibration amplitudes of the fan blades. In particular, the connection of the nose cone embodied with enhanced damping characteristics to the fan disc leads to an increased mechanical damping of that area of the fan disc from which the fan blades project and which is consequently subject to an increased degree of blade vibration. By damping the deflections in this area of the fan disc, the vibration of the fan blades is damped, as well. The energy absorbed by the damping is dissipated inside the elastomer that is integrated inside the nose cone.

Moreover, the present invention makes it possible to reduce the wall thickness of a nose cone as compared to the wall thickness of a nose cone that is embodied as a pure fiber-reinforced composite structural component, since the resilience against impacts and thus the impact strength of the composite is increased thanks to the integration of an elastomer. By reducing the wall thickness of the nose cone, the manufacturing effort and costs can be reduced.

Thus, the present invention facilitates a reduced amplitude of a fan blade in the event of vibration stimulation. This is accompanied by a lower vibration stress level and, as a result thereof, a prolonged service life of the structural component. In addition, a lower nose cone mass can be achieved while the impact strength remains unchanged.

According to one embodiment of the invention, the cone part has multiple material layers, wherein at least one of the material layers consist of an elastomer or comprises an elastomer. Here, it is provided in one embodiment that the material layers extend substantially parallel to each other and to the outer surface of the cone part. At that, the individual material layers form curved planes, namely also conical surfaces corresponding to the shape of the cone part. Here, it can be provided that the thickness of the individual material layers decreases towards the tip of the cone part in order to reduce the overall material thickness in the area of the tip of the cone part.

However, according to one embodiment, the at least one material layer made of or containing an elastomer is not the outermost material layer of the cone part. The outermost material layer of the cone part is made of a fiber-reinforced synthetic material which provides a rigid outer shell of the cone part.

It is to be understood that the integration of an elastomer in the fiber-reinforced synthetic material of the cone part is not necessarily realized by virtue of one or multiple material layers being formed by or containing the elastomer. Depending on the type of manufacture of the nose cone, other ways of integrating an elastomer are also conceivable, for example by configuring the elastomer in the form of spherical, cylindrical or cuboid islands within the fiber-reinforced synthetic material.

It is provided in one embodiment of the invention that the elastomer is provided as a planar layer with a top side and a bottom side, wherein a layer of fiber-reinforced synthetic material adjoins the top side and/or the bottom side. The bond of layers that is thus provided provides three material layers of the nose cone. Here, it can be provided in one embodiment variant that the cone part consists of three material layers that are made in this manner. In alternative embodiment variants, it can be provided that the cone part has further material layers. For example, it can be provided that initially one or multiple material layers of fiber bundles are placed or coiled, subsequently the mentioned bond of layers is placed on the already existing material layers, and then one or multiple material layers of fiber bundles are placed or coiled again, if necessary. Coiling of a nose cone by using fiber bundles is known from the printed documents EP 1 832 733 B1, DE 10 2010 005 986 A1 and DE 10 2010 005 987 B4, for example, which are explicitly referred to with regard to manufacturing such material layers.

In an alternative embodiment of the invention, it is provided that the elastomer forms the sheathing of a carrier fiber, which is coiled for the purpose of manufacturing of at least one material layer of the nose cone. At that, the elastomer is for example provided through an extrusion method as a sheathing of a carrier fiber. In this variant, it can for example be provided that initially one or multiple layers from fibers or fiber bundles of carbon and/or aramid and/or glass are coiled according to the printed documents EP 1 832 733 B1, DE 10 2010 005 986 A1, and DE 10 2010 005 987 B4, then this coiling process is interrupted and one layer is created by using a fiber sheathed with an elastomer or a fiber bundle that is formed by such fibers, and subsequently one or multiple layers of fibers or fiber bundles of carbon and/or aramid and/or glass are coiled again.

As has already been mentioned, the cone part according to one embodiment of the invention has at least one material layer that is formed by a fiber-reinforced material with coiled glass fiber bundles and/or aramid fiber bundles and/or carbon fiber bundles.

An elastomer that is used according to the invention is a rubber, for example. What is meant by rubber within the meaning of the present invention is any vulcanized rubber, natural rubber as well as synthesized rubber. According to another exemplary embodiment, the elastomer is a viscoelastic material that has a partially elastic, partially viscous material behavior. Of particular interest here are so-called Kelvin bodies, which time-dependently deform like a fluid, but to a limited degree and in a reversible manner like a solid body.

Further, it can be provided that the elastomer is configured in such a manner that it chemically bonds with the synthetic material matrix of the fiber-reinforced synthetic material or the respective resins during the manufacturing process of the fiber-reinforced synthetic material. For example, it is vulcanized at temperatures between 150° C. and 220° C., that is, at temperatures at which the matrix materials of fiber-reinforced synthetic materials are typically cured, as well.

The fiber-reinforced material can for example be a fiberglass-reinforced material, an aramid fiber-reinforced material, or a carbon reinforced material. The fiber-reinforced material may be a synthetic material.

The nose cone can be formed in a conical, elliptical or conical/elliptical manner in different exemplary embodiments. Thus, a cone within the meaning of the present invention comprises also elliptical and conical/elliptical shapes. In a strictly conical shape, a conus with straight outer walls is present. In a conical/elliptical shape, the nose cone is designed as a conus with straight outer walls where it adjoins the tip, and then gradually transitions into an elliptical shape.

The elastomer has a higher elasticity or a lower modulus of elasticity than the fiber-reinforced material by which the cone part is otherwise formed. Preferably, the modulus of elasticity of the elastomer is smaller than the modulus of elasticity of the fiber-reinforced material in the longitudinal direction of the fibers by at least the factor 10, in particular by at least the factor 50, in particular by at least the factor 100, in particular by at least the factor 500, in particular by at least the factor 1000.

In a further aspect of the invention, the invention relates to a fan of an aircraft engine, comprising:
a fan disc,
a plurality of fan blades that are connected to the fan disc, and
a nose cone according to the invention that is arranged upstream of the fan disc and connected to the fan disc.

Here, the nose cone can be mechanically connected to an area of the fan disc, wherein the nose cone damps mechanical vibrations of this area of the fan disc as well as the fan blades connected thereto. For example, the nose cone is mechanically connected to a radially outer connection structure of the fan disc.

Here, it is provided according to one embodiment that the nose cone is connected to the fan disc by means of a flange connection.

According to one embodiment of the invention, the fan is embodied in BLISK design (BLISK=“blade integrated disc”), i.e., as a structural component that is formed in one piece and comprises the fan blades as well as the fan disc. What is present is an integral blade-disc design. Through this design, separate blade-disc connections that are otherwise necessary can be omitted. Further, the fan can principally also be embodied in BLING design (BLING=“bladed ring”). In this design, the blades are manufactured integrally with the supporting ring, similar to a BLISK design. However, principally the fan can be manufactured in a conventional manner with the realization of blade-disc connections.

In a further aspect of the invention, the invention relates to an aircraft engine with a fan according to the invention. The aircraft engine can for example be a jet engine, for example a turbofan engine.

In a further aspect of the invention, the present invention relates to an aircraft engine, comprising:
a fan that comprises: a fan disc; a plurality of fan blades that are connected to a fan disc; and a nose cone that is mechanically connected to the fan disc;
wherein the nose cone has a cone part consisting of multiple material layers,
wherein at least the outermost of the material layers is made of a fiber-reinforced material, and
wherein at least one of the material layers is made of an elastomer or contains an elastomer.

In one exemplary embodiment, the at least one material layer that is made of an elastomer or contains an elastomer is formed by a planar elastomer layer.

In another exemplary embodiment, the at least one material layer that is made of an elastomer or contains an elastomer has a carrier fiber that is sheathed with an elastomer and that is coiled for the purpose of manufacturing this material layer.

### BRIEF DESCRIPTION OF THE DRAWINGS

The invention will be explained in more detail on the basis of exemplary embodiments with reference to the accompanying drawings in which:

FIG. 1 shows a simplified schematic sectional view of an aircraft engine that is configured as a double-flow jet engine and that comprises a fan and a nose cone;

FIG. 2 shows a simplified schematic rendering of the connection of a fan to a nose cone;

FIG. 3 shows a partially sectioned view of an exemplary embodiment of a nose cone;

FIG. 4 shows an exemplary embodiment of a bond of layers that comprises an elastomer layer, wherein the bond of layers is used for manufacturing a nose cone;

FIG. 5 shows a top view of the bond of layers of FIG. 4 before it is coiled for the purpose of creating the material layers of the nose cone;

FIG. 6 shows a sectional view of a nose cone that is manufactured with the bond of layers of FIG. 4;

FIG. 7 shows a schematic rendering of a carrier fiber that is sheathed with an elastomer, wherein the carrier fiber is used for manufacturing at least one layer of a nose cone;

FIG. 8 shows a graphical rendering of the damping characteristics of a nose cone with an integrated elastomer and of a nose cone that is made completely of fiber-reinforced material; and

FIG. 9 shows a graphical rendering of the force progression during an impact test when using a nose cone with integrated elastomer and when using a nose cone that is made completely of fiber-reinforced material.

### DETAILED DESCRIPTION

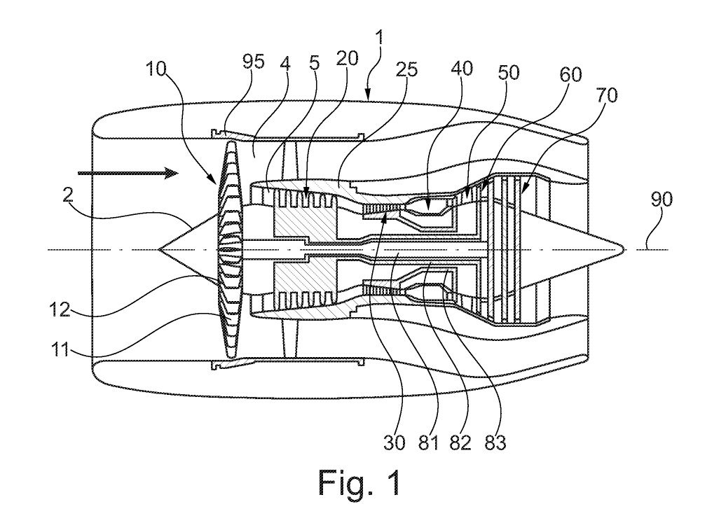

FIG. 1 schematically shows a double-flow jet engine 1 that has a fan stage with a fan 10 as the low-pressure compressor, a medium-pressure compressor 20, a high-pressure compressor 30, a combustion chamber 40, a high-pressure turbine 50, a medium-pressure turbine 60, and a low-pressure turbine 70.

The medium-pressure compressor 20 and the high-pressure compressor 30 respectively have a plurality of compressor stages that respectively comprise a rotor stage and a stator stage. The jet engine 1 of FIG. 1 further has three separate shafts, a low-pressure shaft 81 which connects the low-pressure turbine 70 to the fan 10, a medium-pressure shaft 82 which connects the medium-pressure turbine 60 to the medium-pressure compressor 20, and a high-pressure shaft 83 which connects the high-pressure turbine 50 to the high-pressure compressor 30. However, this is to be understood to be merely an example. If, for example, the jet engine has no medium-pressure compressor and no medium-pressure turbine, only a low-pressure shaft and a high-pressure shaft would be present.

The fan 10 has a plurality of fan blades 11 that are connected to a fan disc 12. Here, the annulus of the fan disc 12 forms the radially inner delimitation of the flow path through the fan 10. Radially outside, the flow path is delimited by a fan housing 95. A nose cone 2 is arranged upstream of the fan disc 12.

Behind the fan 10, the jet engine 1 forms a secondary flow channel 4 and a primary flow channel 5. The primary flow channel 5 leads through the core engine which comprises the medium-pressure compressor 20, the high-pressure compressor 30, the combustion chamber 40, the high-pressure turbine 50, the medium-pressure turbine 60, and the low-pressure turbine 70. At that, the medium-pressure compressor 20 and the high-pressure compressor 30 are surrounded by a circumferential housing 25 which forms an annulus surface at the internal side, delimitating the primary flow channel 5 radially outside. Radially inside, the primary flow channel 5 is delimitated by corresponding rim surfaces of the rotors and stators of the respective compressor stages, or by the hub or elements of the corresponding drive shaft connected to the hub.

The described components have a common symmetry axis 90. The symmetry axis 90 defines an axial direction of the aircraft engine. A radial direction of the aircraft engine extends perpendicularly to the axial direction.

In the context of the present invention, the fan 10 and the nose cone 2 are of particular importance, as will be explained in the following.

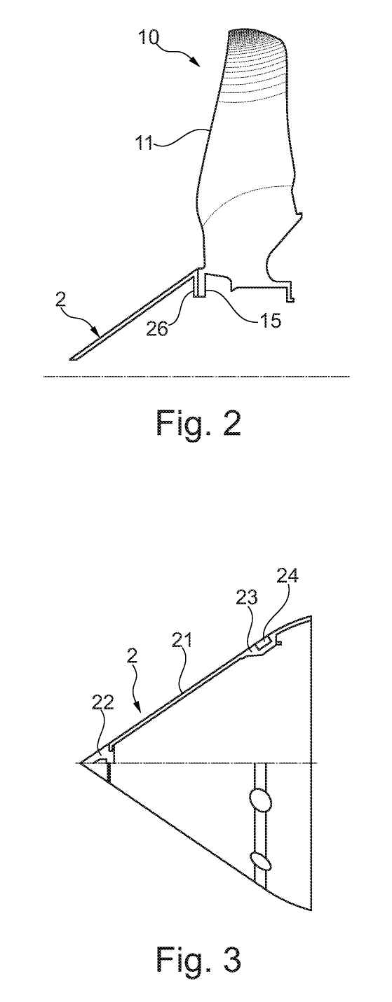

FIG. 2 shows a fan blade 11 of a fan 10 in an exemplary manner. The fan 10 has connection means 15 that serve for mounting the nose cone 2 at the fan 10. The connection means 15 are shown in a schematic manner in FIG. 2, and are for example realized through a flange that forms the fan disc or a part connected to the fan disc. The nose cone 2 has connection means 26 that facilitate a secure mechanical connection of the nose cone 2 to the fan 10. According to the exemplary rendering of FIG. 2, this may be a flange that provides a flange connection together with the flange 15 of the fan 10. It is to be understood that the connection of the nose cone 2 to the fan 10 can principally also be established in a different manner, also by using intermediate parts that are connected to the nose cone 2 and/or the fan 10.

FIG. 3 shows an exemplary embodiment of a nose cone 2 in a partial top view and a partially sectioned view. The nose cone 2 comprises a cone part 21, a cone tip 22, a material reinforcement 23 and openings 24 that are formed in the area of the material reinforcement 23 and that respectively serve for receiving and passing a screw that is not shown here.

The cone part 21 consist of a plurality of material layers, which will be explained in the following, wherein at least one of the material layers comprises an elastomer or is made of an elastomer in its entirety. The optional cone tip 22 is conventionally made of rubber and serves for counteracting any icing of the nose cone 2. If the nose cone 2 does not have a separate cone tip 2, the cone part 21 also forms the cone tip. The material reinforcement 23 and the openings 24 serve for connecting the nose cone 2 to the fan, wherein for example screws that are inserted into the openings 24 are screwed on at a flange of the fan.

The nose cone 2 of FIG. 3 substantially has a conical shape, that is, it is formed by a conus with an outer wall that extends in a linear manner. The nose cone 2 is slightly flattened only at its end that is facing towards the fan. However, this shape of the nose cone 2 is only used by way of example. Alternatively, the nose cone 2 can also be configured in an elliptical or a conical/elliptical manner.

As has already been mentioned, the cone part 21 consists of a plurality of material layers. Here, according to an embodiment variant, the material layers extend substantially parallel to the outer surface of the cone part 21, that is, a section perpendicular to the surface cuts through all material layers.

Here, at least the outermost material layer of the cone part 21, which forms the shell of the cone part 21, consists of a fiber-reinforced material, for example one made of a fiberglass-reinforced material, from an aramid fiber-reinforced material, or from a carbon fiber-reinforced material. The manufacture of such a material layer from fiber-reinforced material can be carried out in a per se known manner, for example by placing individual layers, by coiling a fiber or a fiber bundle, wherein the fibers or the fiber bundle are either already embedded in a resin during the coiling process or are impregnated with a resin after having been coiled. Such coiling methods are described in the printed documents EP 1 832 733 B1, DE 10 2010 005 986 A1 and DE 10 2010 005 987 B4, for example.

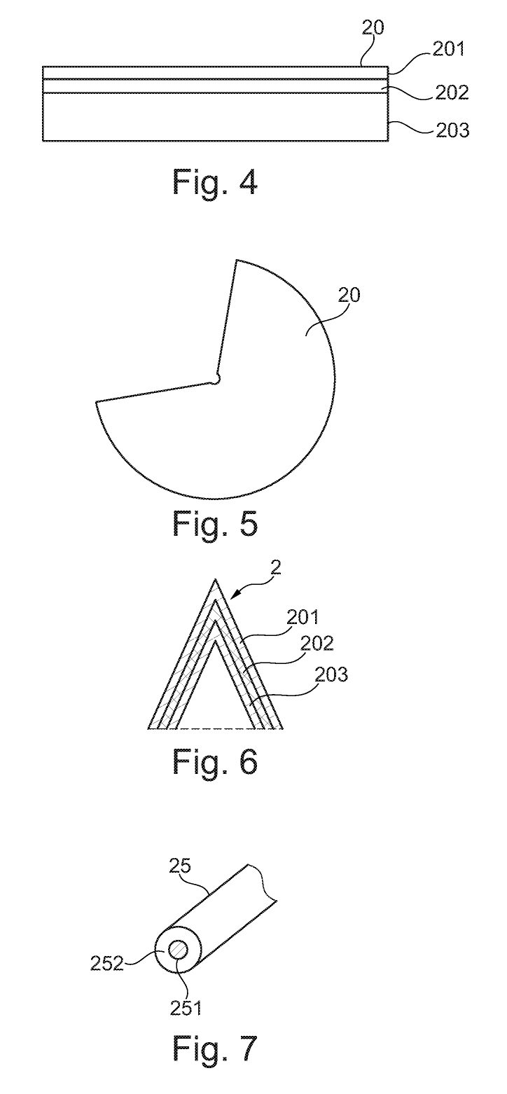

Further, the cone part 21 has at least one material layer that consist: of an elastomer. An exemplary embodiment of this is shown in FIG. 4. FIG. 4 shows a sectional view of a bond of layers 20 that has three plies or material layers 201, 202 and 203. The layers 201 and 203 consist of a fiber-reinforced synthetic material. In contrast, the layer 202 consists of an elastomer. For example, the layer 202 is provided by a rubber or a viscoelastic material. Here, the elastomer is selected in such a manner that it is vulcanized together with the fiber-reinforced synthetic material of the material layers 201, 203 at a temperature of for example 150° C. to 220° C. In this manner, an integrally joined manufacture of all material layers 201, 202, 203 of the bond of layers 20 is facilitated in a simple manner.

FIG. 5 shows the bond of layers 20 of FIG. 4 in a top view. In the shown exemplary embodiment, the bond of layers 20 is configured as a circular sector and is provided and suited for the purpose of being coiled onto a hub, which results in the desired conical shape. According to an alternative exemplary embodiment, instead of on a hub, the bond of layers 20 can also be placed on a previously manufactured material layer of a fiber-reinforced synthetic material.

FIG. 6 shows a sectional view of a nose cone 2 that has been manufactured by means of the bond of layers 20 of FIGS. 4 and 5. In the exemplary embodiment of FIGS. 4 to 6, the nose cone 2 does not have a separate rubber tip and consists of the cone part only. Alternatively, a separate rubber tip could be present, in which case the bond of layers 20 is correspondingly adjusted in the area of the tip.

As can be seen in the sectional view of FIG. 6, the nose cone 2 has three material layers 201, 202, 203, wherein the elastomer layer 202 is located between the layers 201 and 203 of fiber-reinforced synthetic material. Where it internally adjoins the inner material layer 203, the nose cone 2 is hollow, that is, the nose cone 2 represents a conically shaped hollow element. This applies to all exemplary embodiments of the invention.

In alternative exemplary embodiments, the nose cone 2 has a different number of material layers, for example 2, 4, 5 or 6 material layers. In the case of only two material layers, the material layer of fiber-reinforced synthetic material forms the outer layer, and the layer consisting of the elastomer forms the inner layer. When more than three material layers are present, it can be provided that, in addition to the bond of layers according to FIGS. 4 and 5, material layers of fiber-reinforced material are realized, for example that the bond of layers 20 according to FIGS. 4 and 5 is coiled onto a previously manufactured material layer of fiber-reinforced synthetic material.

In alternative exemplary embodiments is can also be provided that two bonds of layers 20 according to FIGS. 4 and 5 are placed on top of each other, resulting in a total of six layers, of which two layers are elastomer layers. These alternatives illustrate the exemplary character of the exemplary embodiments of FIGS. 4 to 6.

FIG. 7 shows an exemplary embodiment in which an elastomer is provided not in the form of a homogeneous layer inside the nose cone 2, such as the layer 202 of FIG. 4, but as a fiber 25 in which a carrier fiber 251 is sheathed with an elastomer 252. The carrier fiber 251 can for example be a carbon fiber, or an aramid fiber, or a glass fiber. However, other fibers may also be used. The sheathing of the carrier fiber 251 with the elastomer 252 is for example carried out by applying an extrusion process, wherein the fiber 251 is guided through a nozzle while being sheathed with an elastomer 252. An elastomer can for example be a rubber or a viscoelastic elastomer.

A nose cone 2 consisting or multiple layers or its cone part 21 (cf. FIG. 3) is for example manufactured by using the sheathed carrier fiber 251 of FIG. 7, namely in such a manner that first one or multiple material layers of fiber-reinforced material are coiled, for example according to a coiling method as it is described in the printed documents EP 1 832 733 B1, DE 10 2010 005 986 A1, and DE 10 2010 005 987 B4. Subsequently, a material layer having fibers 25 that are sheathed with an elastomer 252 according to FIG. 7 is coiled onto the existing material layer, wherein the fibers 25 can be combined into fiber bundles. After this layer has been coiled, one or multiple other layers of fiber-reinforced material can be coiled onto the layer coiled with the rubberized fiber 25. At that, the coiled fibers are impregnated with a resin either before or after that process, wherein the curing or vulcanization of all layers is carried out simultaneously according to one embodiment variant. However, this is not obligatory. Alternatively, the respective individual layers can be cured individually, wherein another layer is subsequently coiled onto a cured layer.

In other exemplary embodiments, it is not fibers or fiber bundles that are being placed, but fiber compounds that are arranged in a planar manner, for example fiber compounds arranged in the form of strips. In general, this does not result in any differences with respect to the manufacture of a nose cone 2.

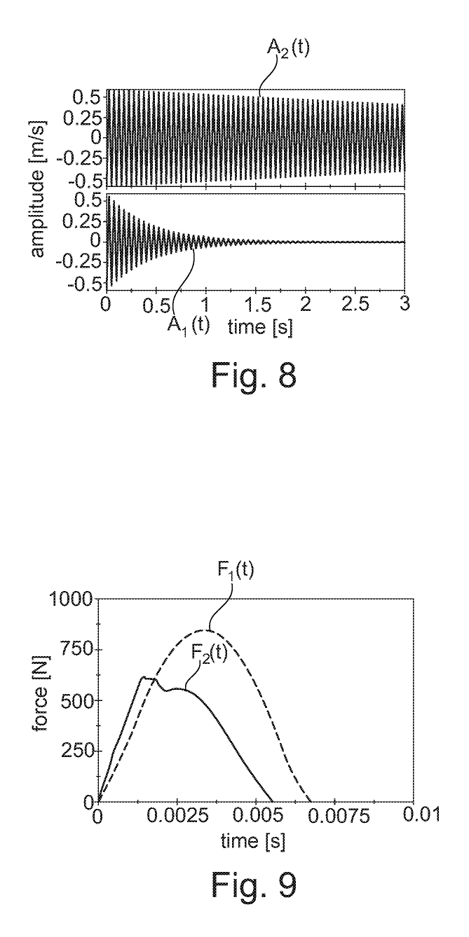

FIG. 8 illustrates the advantages of the present invention with respect to the vibration behavior of a fan blade of a fan. FIG. 8 shows the vibration curve A₁(t) of a nose cone for when a layer structure according to the invention is used, and a vibration curve A₂(t) for when a conventional nose cone is used. What is shown is the attenuation of the vibration of the nose cone following excitation. As can clearly be seen that the vibration curve A₁(t) is considerably damped as compared to the vibration curve A₂(t), i.e., the vibration of the nose cone and of the fan connected thereto (e.g., a fan BLISK or a fan BLING) is increasingly damped. Here, the mechanism works in such a manner that the damping nose cone absorbs vibrations that are transferred to the nose cone via the connection between the fan disc and the nose cone. In the process, the corresponding area of the fan disc is damped, which in turn leads to a damping of the vibrations of the fan blades. In particular, the connection of the fan disc to the nose cone is realized in the radially outer area of the fan disc, namely at the annulus of the fan disc from which the fan blades project, or in the area adjoining the same. Due to the damping of the vibrations in the area of the annulus of the fan disc, the blade vibrations are damped, as well. This particularly applies if the fan is configured in BLISK design or BLING design.

FIG. 9 illustrates the advantages of the present invention with respect to the impact strength of the nose cone. FIG. 9 shows the force progression during impact F₁(t) for when a nose cone according to the invention is used, and the impact behavior F₂(t) for when a conventional nose cone is used. When a nose cone according to the invention is used, stronger forces can be absorbed, wherein the absorbed forces are absorbed by the damping material over a longer period of time. Accordingly, the impact strength of the compound is increased through the integration of an elastomer, which makes it possible to reduce the material thickness of the nose cone, while the impact strength remains the unchanged.

The invention is not limited in its design to the exemplary embodiments described above, which are to be understood merely as examples. For instance, the mentioned elastomers, the shown number of material layers and their arrangement, the shape of the nose cone and the type of its connection to the fan represent merely exemplary implementations of the invention.

It is furthermore pointed out that the features of the individually described exemplary embodiments of the invention can be combined in various combinations with one another. Where areas are defined, they include all the values within these areas and all the sub-areas falling within an area.

What is claimed is:

1. Nose cone for a fan of an aircraft engine comprising:
a cone part of fiber-reinforced material, and
an elastomer integrated into the cone part.

2. Nose cone according to claim 1, wherein the cone part has multiple material layers, and that at least one of the material layers consists of an elastomer or comprises an elastomer.

3. Nose cone according to claim 2, wherein the material layers substantially extend in parallel to each other and to the outer surface of the cone part.

4. Nose cone according to claim 2, wherein the elastomer is provided as a planar layer with a top side and a bottom side, wherein a layer of fiber-reinforced synthetic material adjoins the top side and/or the bottom side, and wherein this bond of layers forms material layers of the cone part.

5. Nose cone according to claim 1, wherein the elastomer forms the sheathing of a carrier fiber which has been used for manufacturing the cone part.

6. Nose cone according to claim 2, wherein the cone part has at least one material layer that is formed by the fiber-reinforced synthetic material comprising coiled glass fiber bundles and/or carbon fiber bundles.

7. Nose cone according to claim 1, wherein the elastomer is a rubber.

8. Nose cone according to claim 1, wherein the elastomer is a viscoelastic material.

9. Nose cone according to claim 1, wherein the elastomer is configured in such a manner that it bonds with the synthetic material matrix of the fiber-reinforced material during the curing process of the fiber-reinforced material.

10. Nose cone according to claim 1, wherein the elastomer is configured in such a manner that it is vulcanized at temperatures between 150° C. and 220° C.

11. Nose cone according to claim 1, wherein the fiber-reinforced material is a fiberglass-reinforced material, or an aramid fiber-reinforced material, or a carbon fiber-reinforced material.

12. Nose cone according to claim 1, wherein the nose cone is configured in a conical or conical/elliptical manner.

13. Nose cone according to claim 1, wherein the elastomer has a modulus of elasticity that is smaller than the modulus of elasticity of the fiber-reinforced material in the longitudinal direction of the fibers by at least the factor 10, in particular by at least the factor 50, in particular by at least the factor 100, in particular by at least the factor 500, in particular by at least the factor 1000.

14. Fan of an aircraft engine, comprising:
a fan disc,
a plurality of fan blades that are connected to the fan disc, and
a nose cone according to claim 1 that is arranged upstream of the fan disc and connected to the fan disc.

15. Fan according to claim 14, wherein the nose cone is connected to the fan disc by means of a flange connection.

16. Fan according to claim 14, wherein the fan is embodied in BLISK design or in BLING design.

17. Aircraft engine comprising a fan according to claim 14.

18. Aircraft engine, comprising:
a fan, comprising:
a fan disc,
a plurality of fan blades, that are connected to the fan disc, and
a nose cone that is mechanically connected to the fan disc,
wherein the nose cone has a cone part that consist of multiple material layers,
wherein at least the outermost of the material layers is made of a fiber-reinforced material, and
wherein at least one of the material layers is made of an elastomer or contains an elastomer.

19. Aircraft engine according to claim 18, wherein the at least one material layer that is made of an elastomer or contains an elastomer is formed by a planar elastomer layer.

20. Aircraft engine according to claim 18, wherein the at least one material layer that is made of an elastomer or contains an elastomer comprises a carrier fiber that is sheathed by an elastomer and that has been coiled for the purpose of manufacturing this material layer.
